(19) United States
(12) Patent Application Publication
(10) Pub. No.: US 2005/0141037 A1
(43) Pub. Date: Jun. 30, 2005

(54) Method and apparatus to enhance printing quality of laser printer

(76) Inventor: Sang-youn Shin, Seoul (KR)

Correspondence Address: STANZIONE & KIM, LLP, 1740 N STREET, N.W., FIRST FLOOR, WASHINGTON, DC, 20036, US

(21) Appl. No.: 10/981,512

(22) Filed: Nov. 5, 2004

(30) Foreign Application Priority Data
Dec. 29, 2003 (KR) 2003-99043

(51) Int. Cl. H04N 1/405; G06T 5/00; H04N 1/409

(52) U.S. Cl. 358/3.15; 358/3.27; 358/3.2

(57) ABSTRACT

A method of and apparatus to enhance the printing quality of a laser printer, in which a window to define a binary image is generated using a plurality of Ipi values and angles of a dithering mask and the quality of a non-edge region is improved. The method of enhancing the printing quality of a laser printer using a 1-bit gray process includes: receiving a binary image, a dithering mask, and a plurality of values of Ipi and angles of the dithering mask, wherein Ipi indicates the number of lines per inch; generating a window having a size of N×N pixels considering the received values of Ipi and angles; determining whether a binary image of N×N pixels, which is defined by the window, is an edge region or not using the window and the dithering mask; and enhancing the quality of a binary image of N×N pixels determined to be a non-edge region. Using a plurality of Ipi values and angles of the dithering mask improves the quality of color images, which require several channels for printing.

### CROSS-REFERENCE TO RELATED APPLICATIONS

This application claims the benefit of Korean Patent Application No. 2003-99043, filed on Dec. 29, 2003, in the Korean Intellectual Property Office, the disclosure of which is incorporated herein in its entirety by reference.

### BACKGROUND OF THE INVENTION

1. Field of the Invention

The present general inventive concept relates to a method of and apparatus to enhance the printing quality of a laser printer, and more particularly, to a method of and apparatus to enhance the printing quality of a laser printer, in which a window is generated using various values of Ipi and angles of a dithering mask to improve the quality of a non-edge image.

2. Description of the Related Art

Generally, a monochromic or color laser printer expresses images on a subpixel-based gray scale. A gray scale representation in which each pixel is expressed in various gray levels requires a large amount of data to be processed. Accordingly, a large amount of data is transmitted from a computer to a laser printer to process various gray scale pixels, and as such, data transmission time increases and a greater capacity memory is required for the laser printer. A general 1-bit gray scale representation involves halftone processing of simply turning on or off pixels or dots. However, halftone images look rough, especially, in lighter areas. To solve this problem, U.S. patent Publication No. 2003-0038853 discloses a method of determining the size of dots according to gray levels of pixels.

In a conventional 1-bit gray scale representation, an input halftone image of 9×4960 pixels is read in units of a window of 9×9 pixels to increase the number of pixels in the halftone image. The 1-bit gray process is performed while moving the window from the left to the right in units of a row, to a next line after the completion of the 1-bit gray process, and then from the left to the right of the next line in units of a row.

Before performing a 1-bit gray process, it is determined whether a window region is an edge region or not. This is because a boundary of the edge area becomes scattered when the edge is enhanced, and accordingly, the edge should not be enhanced.

FIG. 1 is a view of a window used in a conventional edge detection method.

Referring to FIG. 1, an image region surrounded by the window is detected to be an edge area if the following conditions are met:
1) a pixel marked with [symbol] has at least one dot.
2) the center pixel marked with ⊚ has no dot, only one of four pixels 110,120,130, and 140 marked with ● has a dot, and three pixels marked with ♦, surrounding the pixel 110, 120, 130, or 140 including the dot have one or more dots,
3) the center pixel marked with ⊚ has no dot, only two adjacent pixels of the four pixels 110, 120, 130, and 140 marked with ● have a dot and the other two pixels have no dot.

After the edge detection as described above is performed, image quality enhancement is performed on non-edge areas.

FIG. 2 is a view of a window used in a conventional image enhancement method. The window has a size of 10×9 pixels and is used in a 1-bit gray process.

Referring to FIG. 2, the sum of the average value of the brightness of a pixel 200 to be enhanced and four pixels 201, 202, 203, and 204, which are diagonally separated from the pixel 200 by a distance of 342, and the average value of the brightness of a pixel 210 on the left of the pixel 200 and four pixels 211, 212, 213, and 214, which are diagonally separated from the pixel 210 by a distance of 342, is set as a target brightness value or size of the pixel 200 to be enhanced. The target brightness value of the pixel 200 may range from 0/10 to 10/10, resulting in enhanced, smoother images. Each pixel consists of 0/10 to 10/10 dots, and therefore the brightness can be set according to the number of dots in a pixel.

The above-described 1-bit gray method can be used with a dithering mask having an Ipi value of 141 and an angle of 45 degrees, in which the Ipi value indicates the number of lines per inch. A Ipi value is obtained by dividing the number of dots per inch (dpi) by the distance between printed dots. For example, when the number of dpi is 600 and the distance between printed dots is 342, the number of Ipi is 600/3√2=141. The angle between printed dots is 45 degrees in FIG. 2. Referring to FIG. 2, since the pixel 202 is located three pixels to the right of and three pixels above the center pixel 200, the distance between the pixels 202 and 200 is 3√2 and the angle between the pixels 202 and 200 is 45 degrees.

As described above, the conventional 1-bit gray process can be used for quality enhancement only at a particular Ipi and angle, and cannot be used when dithering multi-channel images such as color images. When color images of cyan, magenta, yellow, and black are printed using a dithering mask having an Ipi of 141 and an angle of 45 degrees, there may be problems.

### SUMMARY OF THE INVENTION

The present general inventive concept provides a method of enhancing the printing quality of a laser printer using in a 1-bit gray process a window generated based on a plurality of Ipi values and angles, not a particular value of Ipi and angle, of a dithering mask.

The present general inventive concept also provides an apparatus to enhance the printing quality of a laser printer using in a 1-bit gray process a window generated based on a plurality of Ipi values and angles, not a particular value of Ipi and angle, of a dithering mask.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of enhancing the printing quality of a laser printer using a 1-bit gray process, the method comprising: receiving a binary image, a dithering mask, and a plurality of values of Ipi and angles of the dithering mask, wherein Ipi indicates the number of lines per inch; generating a window having a size of N×N pixels considering the received values of Ipi and angles; determining whether a binary image of N×N pixels, which is defined by the window, is an edge region or not using the window and the dithering mask; and enhancing the quality of a binary image of N×N pixels determined to be a non-edge region.

The foregoing and/or other aspects and advantages of the present general inventive concept are also achieved by providing an apparatus to enhance the printing quality of a laser printer using a 1-bit gray process, the apparatus comprising: a reception unit receiving a binary image, a dithering mask, and a plurality of values of Ipi and angles of the dithering mask, wherein Ipi indicates the number of lines per inch; a window generation unit generating a window having a size of N×N pixels considering the received values of Ipi and angles; an edge detection unit determining whether a binary image of N×N pixels, which is defined by the window, is an edge region or not using the window and the dithering mask; and an enhancement unit enhancing the quality of a binary image of N×N pixels determined to be a non-edge region.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view of a window used in a conventional edge detection method;

FIG. 2 is a view of a window used in a conventional image enhancement method;

FIG. 3 is a block diagram of an image enhancement apparatus according to an embodiment of the present general inventive concept;

FIG. 4 is a flowchart illustrating an image enhancement method according to an embodiment of the present general inventive concept;

FIG. 5 is a flowchart of an edge detection method according to an embodiment of the present general inventive concept;

FIG. 6 is a flowchart of a method of calculating the size of dots in a center pixel according to an embodiment of the present general inventive concept;

FIG. 7 is a view of a window used to detect the positions of neighboring pixels around the center pixel;

FIG. 8A is a view of a binary image window before quality enhancement; and

FIG. 8B is a view of a binary image window after quality enhancement.

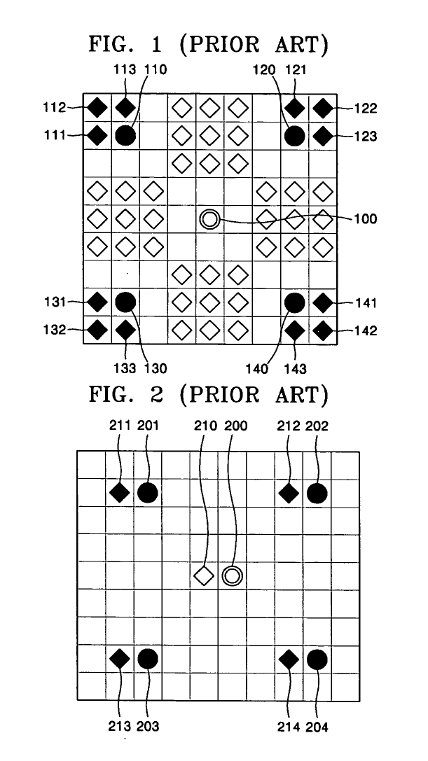

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

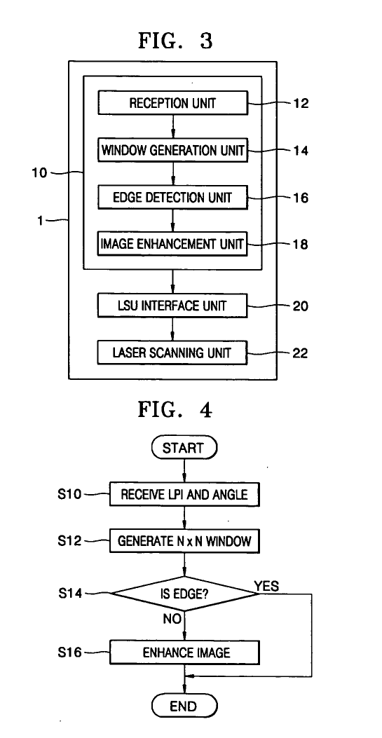

FIG. 3 is a block diagram of an image enhancement apparatus 10 according to an embodiment of the present general inventive concept. The image enhancement apparatus 10 of a laser printer 1 includes a reception unit 12, a window generation unit 14, an edge detection unit 16, and an image enhancement unit 18.

The reception unit 12 receives a binary image, a dithering mask, and values of Ipi and angles of the dithering mask. Here, Ipi indicates the number of lines per inch. The window generation unit 14 generates a window having a size of N×N pixels in consideration of the received values of Ipi and angles. The edge detection unit 16 detects whether a binary image defined by the N×N window is an edge image using the binary image window and the dithering mask. The image enhancement unit 18 enhances the quality of a non-edge binary image having a size of N×N.

In particular, the edge detection unit 16 detects a maximum value among dithering mask values in non-dotted white pixel regions of the binary image and a minimum value among dithering mask values in dotted black pixel regions of the binary image, and compares the maximum value of the white pixel regions and the minimum value of the black pixel regions. If the maximum value of the white pixel regions is not greater than the minimum value of the black pixel regions or if a difference between the maximum value of the white pixel regions and the minimum value of the black pixel regions is not greater than a threshold value, the binary image defined by the window is determined to be a non-edge region. The threshold value may be a value from 0 to 255 and is used to eliminate unnecessary edge components and noise components. A larger threshold value eliminates more edge information. Therefore, in the present general inventive concept, the amount of edge information can be adjusted by varying the threshold value.

The image enhancement unit 18 detects the positions of neighboring pixels surrounding the center pixel in the window using the values of Ipi and angles, the number Pn of the neighboring pixels including the center pixel, and the number Pbn of black pixels among the neighboring pixels and the central pixel. The size of dots or the brightness of the center pixel is calculated using Pbn/Pn×255.

After the enhancement process described above, an enhanced image is transmitted to a LSU (laser scanning unit) interface unit 20, and a pulse signal corresponding to the transmitted image is generated and transmitted to an LSU 22. The LSU 22 performs laser scanning according to the received pulse signal to generate a printed image.

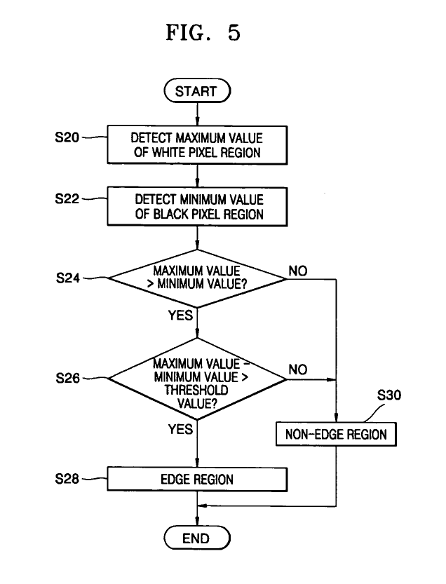

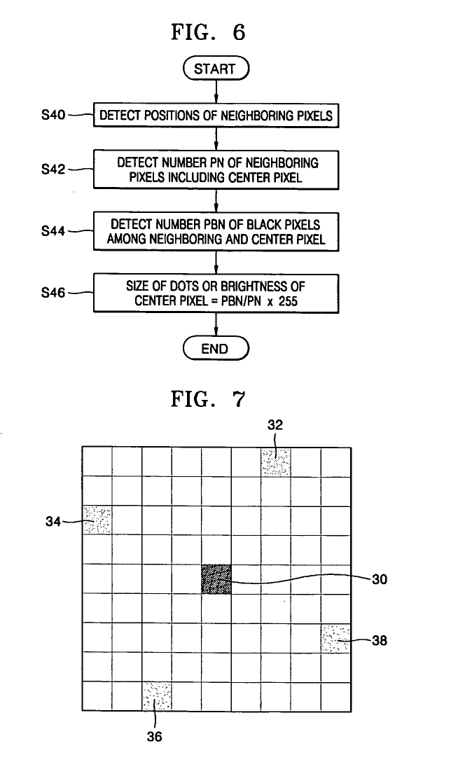

Hereinafter, an image enhancement method according to an embodiment of the present general inventive concept will be described with reference to FIGS. 4 through 6. FIG. 4 is a flowchart of an image enhancement method according to an embodiment of the present general inventive concept, FIG. 5 is a flowchart of an edge detection method according to an embodiment of the present general inventive concept, and FIG. 6 is a flowchart of a method of calculating the size of dots in a center pixel.

Referring to FIG. 4, first, a binary image, a dithering mask, and the values of Ipi and angles of the dithering mask are received (S10). Next, a binary image window having a size of N×N pixels is generated considering the received values of Ipi and angles of the dithering mask (S12). Next, it is determined whether a binary image having a size of N×N pixels, which is defined by the N×N window, is an edge region using the N×N binary image window and the dithering mask (S14). If the binary image of N×N pixels is a non-edge region, an image enhancement process is performed on the non-edge region (S16).

An edge detection method will be described in detail with reference to FIG. 5. First, a window is generated prior to edge detection. The size of the window is determined considering the values of Ipi and angles of the dithering mask. In this embodiment, the size of the window is determined to include the center of a submask of the dithering mask around the center pixel of the window.

Second, a maximum value among dithering mask values in non-dotted white pixel regions of the binary image is determined (S20). A minimum value among dithering mask values in dotted black pixel regions of the binary image is determined (S22). Next, the maximum value of the white pixel regions and the minimum value of the black pixel regions are compared (S24).

If the maximum value of the white pixel regions is not greater than the minimum value of the black pixel regions, the binary image is determined to be a non-edge region (S30). If the maximum value of the white pixel regions is greater than the minimum value of the black pixel regions, a difference between the maximum value of the white pixel regions and the minimum value of the black pixel regions is compared with a threshold value (S26). If the difference between the maximum and minimum values is not greater than the threshold value, the binary image is determined to be a non-edge region (S30). If the difference between the maximum and minimum values is greater than the threshold value, the binary image is determined to be an edge region (S28). The threshold value may be a value from 0 to 255 and is used to eliminate unnecessary edge components and noise components. As the threshold value is set to be larger, more edge information is eliminated. Accordingly, the amount of edge information can be adjusted by varying the threshold value.

A method of enhancing the quality of a non-edge binary image will be described with reference to FIG. 6. Referring to FIG. 6, the positions of neighboring pixels surrounding the center pixel in the window are detected using the values of Ipi and angles (S40). Next, the number Pn of the neighboring pixels including the center pixel is detected (S42), and the number Pbn of black pixels among the neighboring and center pixels is detected (S44). Next, the size of dots or the brightness of the center pixel is calculated using Pbn/Pn×255 (S46).

A technical goal of the present general inventive concept is to enhance the Ipi in a bright region to obtain smoother output images. Generally, in a halftoning process, the brightness of a gray-scale image is expressed using binary values, i.e., in black or white. A binary image can be expressed with more gray levels by using a dithering mask combined from a plurality of dithering submasks. However, in a bright area where no dot exits in a specific dithering submask, the Ipi is deteriorated. Thus, a method of spotting smaller dots in each submask is used. A smoother, higher-resolution output image can be obtained by spotting more bright dots in a region rather than spotting less dark dots in the region to express the same level of brightness.

A method of detecting the positions of neighboring pixels around the center pixel of a window using values of Ipi and angles of the dithering mask will be described with reference to FIG. 7. FIG. 7 is a view of a window used to detect the positions of neighboring pixels around the center pixel.

Referring to FIG. 7, the position of the center pixel of a submask of a dithering mask having 134 Ipi and an angle of 63 degrees is shown. The value of Ipi and the angle are input values. The size of the window and the positions of neighboring pixels surrounding the center pixel are determined using the input value of Ipi and the angle.

The Ipi is a value obtained by dividing the number of dots per inch (dpi) by the distance between printed dots. For example, when dpi is 600 and the distance between dots is 2√5, Ipi is 600/(2√5)=134. The angle is an angle between printed dots. The positions of the neigiboring pixels are determined using the input Ipi and angles. In the case of FIG. 7, an input value of Ipi is 134, an input angle is 63 degrees, and the distance between printed dots is (600 dpi)/(134 Ipi)=4.478≈√20=2√5. Using these values, the positions of the neighboring pixels 32, 34, 36, and 38 with respect to the center pixel 30 in FIG. 7 can be determined.

A conventional 1-bit gray process can be performed only when a dithering mask has 141 Ipi and 45 degrees. However, in the present embodiment, the value of Ipi and the angle of the dithering mask can be varied according to the values input by a user. Exemplary values of Ipi and angles of the dithering mask that can be used are as follows.
1) 141 Ipi and 45 degrees
2) 134 Ipi and 63 degrees
3) 150 Ipi and 90 degrees

In the conventional case (1), referring to FIG. 2, one neighboring pixel 202 among the pixels 201, 202, 203, and 204 surrounding the center pixel 200 is located 3 pixels to the right of and 3 pixels above the center pixel 200 and has an angle of 45 degrees with respect to the center pixel 200. In the present embodiment, case (2), referring to FIG. 7, one neighboring pixel 32 of the pixels 32, 34, 36, and 38 surrounding the center pixel 30 is located 2 pixels to the right of and 4 pixels above the center pixel 30 and has an angle of 63 degrees with respect to the center pixel 30. In the present embodiment case (3), although not shown in the drawings, one of neighboring pixels surrounding the center pixel is located 4 pixels above the center pixel and has an angle of 90 degrees with respect to the center pixel. In this case, the value of 150 Ipi is calculated by dividing 600 dpi by 4.

Unlike the conventional method, a plurality of Ipi values and angles can be used in the present general inventive concept. Therefore, the quality of color images, which require a plurality of channels for printing, also can be improved. In particular, when printing a color image, various values of Ipi and angles for different colors, cyan, magenta, yellow, and black, can be used.

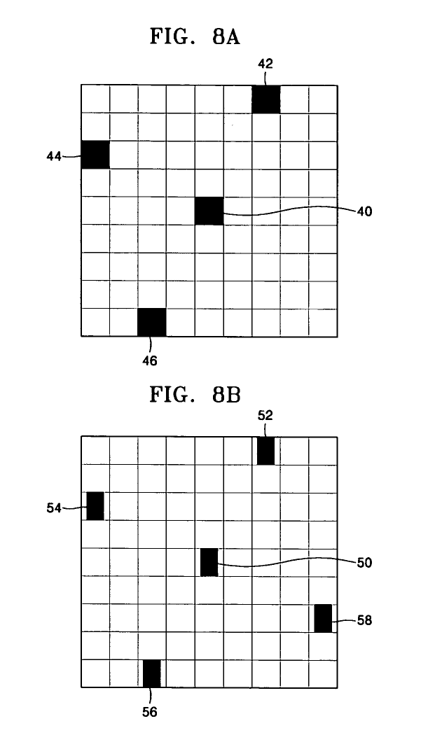

A method of calculating the brightness or the size of dots of a center pixel will be described with reference to FIGS. 8A and 8B. FIGS. 8A and 8B are views of a binary image window before and after quality enhancement, respectively.

As shown in FIG. 8A, dots may be unevenly distributed in a bright gray scale image. A bright printed region has a deteriorated value of Ipi and looks rough. However, a smoother, higher-resolution image can be obtained by uniformly distributing dots in the image region, as shown in FIG. 8B, to enhance quality. The brightness of the image can be adjusted based on the distribution of the center pixels in submasks of the window.

Size of dots or brightness of the center pixel is calculated as described in operation 46 of FIG. 6. Referring to FIG. 8B, the number Pn of the neighboring pixels 52, 54, 56, and 58 including the center pixel 50 is 5 (=4+1), and the number Pbn of block pixels among the neighboring pixels 52, 54, 56, and 58 and the center pixel 50 is 4 (see FIG. 8A). Accordingly, the size of dots or brightness of the center pixel is Pbn/Pn×255 =4/5×255=204. The result of the quality enhancement is shown in FIG. 8B. A pixel of the window that is enhanced by the quality enhancement process is the center pixel.

The enhanced image is transmitted to the LSU interface unit 20 of FIG. 3 to generate a pulse signal corresponding thereto. The pulse signal is transmitted to the LSU 22, and the LSU 22 performs laser scanning according to the received pulse signal to obtain a printed image.

As described above, according to the present general inventive concept, the printing quality of color images, which require several channels for printing, can be enhanced using a plurality of Ipi values and angles of a dithering mask.

In addition, a non-edge region of a dithered binary image is detected by an edge detection method using a plurality of Ipi values and angles of a dithering mask, and dots are uniformly distributed in the non-edge region to enhance the printing quality of the image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of enhancing the printing quality of a laser printer using a 1-bit gray process, the method comprising:
receiving a binary image, a dithering mask, and a plurality of values of Ipi and angles of the dithering mask, wherein Ipi indicates the number of lines per inch;
generating a window having a size of N×N pixels considering the received values of Ipi and angles;
determining whether a binary image of N×N pixels, which is defined by the window, is an edge region or not using the window and the dithering mask; and
enhancing the quality of a binary image of N×N pixels determined to be a non-edge region.

2. The method of claim 1, wherein the determining of whether the binary image is the edge region or not comprises:
detecting a maximum value among dithering mask values in non-dotted white pixel regions of the binary image;
detecting a minimum value among dithering mask values in dotted black pixel regions of the binary image;
comparing the maximum value of the non-dotted white pixel regions with the minimum value of the black pixel regions; and
determining the binary image to be a non-edge region if the maximum value of the white pixel regions not greater than the minimum value of the black pixel regions or if a difference between the maximum and minimum values is not smaller than a threshold value.

3. The method of claim 3, wherein the threshold value is a value from 0 to 255.

4. The method of claim 1, wherein the enhancing of the quality of the binary image comprises:
detecting the positions of neighboring pixels surrounding a center pixel in the window using the values of Ipi and angles of the dithering mask;
detecting the number Pn of the neighboring pixels including the center pixel;
detecting the number Pbn of black pixels among the neighboring pixels and the center pixel; and
calculating the size of dots or the brightness of the center pixel using the formula Pbn/Pn*255.

5. An apparatus to enhance the printing quality of a laser printer using a 1-bit gray process, the apparatus comprising:
a reception unit to receive a binary image, a dithering mask, and a plurality of values of Ipi and angles of the dithering mask, wherein Ipi indicates the number of lines per inch;
a window generation unit to generate a window having a size of N×N pixels considering the received values of Ipi and angles;
an edge detection unit to determine whether a binary image of N×N pixels, which is defined by the window, is an edge region or not using the window and the dithering mask; and
an enhancement unit to enhance the quality of a binary image of N×N pixels determined to be a non-edge region.

6. The apparatus of claim 5, wherein the edge detection unit comprises:
an element to detect a maximum value among dithering mask values in non-dotted white pixel regions of the binary image;
an element to detect a minimum value among dithering mask values in dotted black pixel regions of the binary image;
an element to compare the maximum value of the non-dotted white pixel regions with the minimum value of the black pixel regions; and
an element to determine the binary image to be a non-edge region if the maximum value of the white pixel regions is not greater than the minimum value of the black pixel regions or if a difference between the maximum and minimum values is not greater than a threshold value.

7. The apparatus of claim 6, wherein the threshold value is a value from 0 to 255.

8. The apparatus of claim 5, wherein the enhancement unit comprises:
an element to detect the positions of neighboring pixels surrounding a center pixel in the window using the values of Ipi and angles of the dithering mask;
an element to detect the number Pn of the neighboring pixels including the center pixel;
an element to detect the number Pbn of black pixels among the neighboring pixels and the center pixel; and
an element to calculate the size of dots or the brightness of the center pixel using the formula Pbn/Pn×255.

9. The apparatus of claim 5, wherein the size of the window includes the center of a submask of the dithering mask around the center pixel of the window.

10. An image forming apparatus comprising:
an image enhancement apparatus to receive a binary image, a dithering mask, and a plurality of values of lines per inch (Ipi) and angles of the dithering mask, to generate a window having a size of N×N pixels considering the received values of Ipi and angles, to determine whether a binary image of N×N pixels, which is defined by the window, is an edge region or not using the window and the dithering mask, and to enhance the quality of a binary image of N×N pixels determined to be a non-edge region;
an LSU to perform laser scanning according to a received a pulse signal corresponding to the enhanced image.

11. The image forming apparatus of claim 10, wherein the image enhancement apparatus comprises:
a reception unit to receive the binary image, the dithering mask, and the plurality of values of Ipi and angles of the dithering mask;
a window generation unit to generate the window having a size of N×N pixels considering the received values of Ipi and angles;
an edge detection unit to determine whether a binary image of N×N pixels, which is defined by the window, is an edge region or not using the window and the dithering mask; and
an enhancement unit to enhance the quality of a binary image of N×N pixels determined to be a non-edge region.

12. The image forming apparatus of claim 11, wherein the edge detection unit comprises:
a first detection unit to detect a minimum value among dithering mask values in dotted black pixel regions of the binary image;
a second detection unit to detect a minimum value among dithering mask values in dotted black pixel regions of the binary image;
a comparison unit to compare the maximum value of the non-dotted white pixel regions with the minimum value of the black regions; and
a determination unit to determine the binary image to be a non-edge region if the maximum value of the white pixel regions is not greater than the minimum value of the black pixel regions or if a difference between the maximum and minimum values is not greater than a threshold value.

13. The apparatus of claim 12, wherein the threshold value is a value from 0 to 255.

14. The apparatus of claim 11, wherein the enhancement unit comprises:
a third detection unit to detect the positions of neighboring pixels surrounding a center pixel in the window using the values of Ipi and angles of the dithering mask, the number Pn of the neighboring pixels including the center pixel, and the number Pbn of black pixels among the neighboring pixels and the center pixel; and
a calculation unit to calculate the size of dots or the brightness of the center pixel using the formula Pbn/Pn×255.
